(19) United States
(12) Patent Application Publication
(10) Pub. No.: US 2009/0265749 A1
(43) Pub. Date: Oct. 22, 2009

(54) WIRELESS DISPLAY SYSTEM

(75) Inventor: Hung-Huei Yu, Taipei (TW)

Correspondence Address: Muncy, Geissler, Olds & Lowe, PLLC, P.O. BOX 1364, FAIRFAX, VA, 22038-1364, US

(73) Assignee: SHUTTLE INC.

(21) Appl. No.: 12/106,132

(22) Filed: Apr. 18, 2008

(51) Int. Cl. H04N 7/173

(52) U.S. Cl. 725/116

(57) ABSTRACT

A wireless display system includes at least one information providing unit and a display unit to perform wireless transmission between them through a wireless transmission module. The wireless display system further has an identification (ID) code generation unit in the information providing unit and an ID unit in the display unit. The ID code generation unit generates an ID code corresponding to the information providing unit to the display unit. The ID unit receives the ID code and checks the received ID code through an authentication database. In the event that the ID code matches the authentication database a linking signal is sent to the ID code generation unit to allow the display unit to receive and display video information generated by the information providing unit through the wireless transmission module. The display unit performs wireless transmission of the video information to only the corresponding information providing unit and prevents signal chaos.

### FIELD OF THE INVENTION

The present invention relates to an information transmission method between a display unit and an information providing unit and particularly to an information transmission method to transmit information between a display unit and an information providing unit through a wireless transmission module.

### BACKGROUND OF THE INVENTION

A computer system usually has an information providing unit to perform processing and store information, an input device to enable users to enter data and commands, and an output unit to serve as a communication medium between the users and the information providing unit. A commonly used output unit is a display device. The display device can display information accessed from a host processing unit through pictures shown on a display screen on the display device to allow the users to read visually. Hence the display device is a convenient and useful information access device. The conventional display device is connected to the information providing unit through a linking line such as a Digital Visual Interface (DVI) or Video Graphic Array (VGA) to receive video information from the information providing unit. Due to limitation of the linking line the display device usually has to be installed close to the information providing unit. It is difficult to change the location of the display device to suit user's reading habit or requirements. Hence application of the computer system is constrained.

These days the trend of designing the display device is either maximizing or minimizing the size thereof. As the technologies of resolution and transmission speed are welled developed now, large size display devices have gradually replaced the traditional TVs, and digital video home appliances become a new focus in the industry. On the other hand, small size display devices are widely adopted on portable electronic devices, such as Digital Photo Frames, Personal Digital Assistants (PDAs) and the like. Connecting the display device to the information providing unit through the linking line to transmit information makes using more troublesome. The linking line also is easily entangled and cluttered to make environment untidy.

U.S. Pat. Nos. 6,784,855, 7,183,999 and publication No. 20050289631 disclose wireless transmission techniques to transmit video information from an information providing unit to a display device. Hence the display device is not longer constrained by the traditional linking line. And users can carry the display device wherever they like according to their use habits or requirements. However, in an environment where multiple information providing units are presented, the wireless transmission approaches they proposed could result in a single display device receiving video information from different host processing units and cause processing chaos.

### SUMMARY OF THE INVENTION

The primary object of the present invention is to provide a wireless display system to mate a display device to a single host processing unit to receive video information therefrom. To achieve the foregoing object the wireless display system of the invention includes at least one information providing unit and a display unit to perform wireless transmission between them through a wireless transmission module. The wireless display system further has an identification (ID for short hereinafter) code generation unit in the information providing unit and an ID unit located in the display unit. The ID code generation unit generates an ID code corresponding to the information providing unit to the display unit. The ID unit receives the ID code and checks the received ID code through an authentication database. In the event that the ID code matches the data in the authentication database a linking signal is sent to the ID code generation unit to allow the display unit to receive and display the video information generated by the information providing unit through the wireless transmission module. In the event that the ID code does not match the data in the authentication database, no linking signal is generated.

In another embodiment of the invention the display unit has a transmission unit to generate a detection signal. The information providing unit has a detection unit to receive the detection signal and drive the ID code generation unit to output the ID code to the display unit.

By means of the wireless display system of the invention the display unit can perform checking of the ID code with the information providing unit to be connected, then wireless transmission can be established between the display unit and the information providing unit so that the display device can receive and display the video information from the information proving unit. As a result, the display unit can be used among multiple sets of information providing units. Aside from preventing chaos that might otherwise occur due to concurrent input of video information from the multiple sets of the information providing units to the display unit, there is no need to mate each information providing unit with one display unit. Thus the number of the display unit required is fewer and procurement cost thereof can be reduced, and installation space also can be saved.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of an embodiment of the wireless display system of the invention.

FIG. 2 is a structural block diagram of another embodiment of the wireless display system of the invention.

FIGS. 3A, 3B and 3C are schematic views of the wireless display system of the invention adopted in a wireless transmission environment including a single computer system and a flat panel display device.

FIGS. 4A through 4D are schematic views of the wireless display system of the invention adopted in a wireless transmission environment including a single display unit and multiple sets of information providing units.

### DETAILED DESCRIPTION OF THE PREFERRED EMBODIMENTS

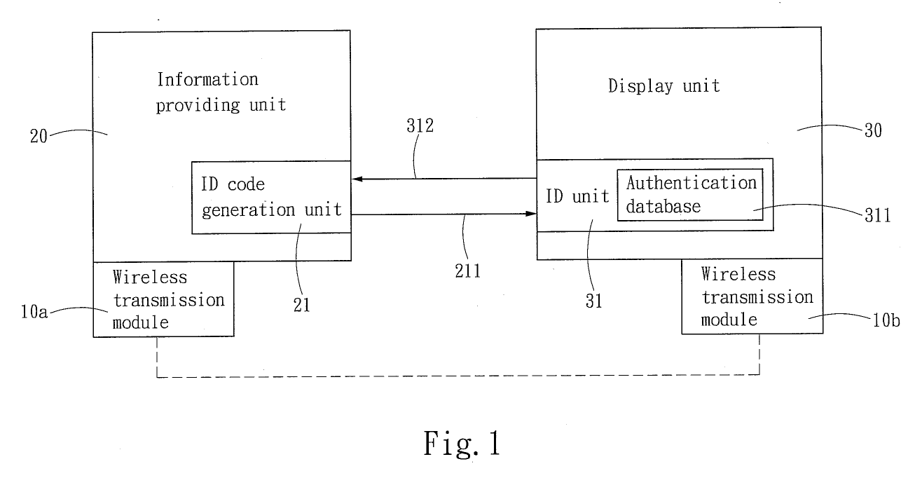

Please refer to FIG. 1 for the structural block diagram of an embodiment of the invention. The wireless display system according to the invention includes at least one information providing unit 20 and a display unit 30 that perform wireless transmission between them through wireless transmission modules 10a and 10b. The wireless transmission modules 10a and 10b are devices to do data transmission in a wireless fashion, such as Bluetooth modules or Wireless Universal Series Bus (WUSB) Modules or the like. The wireless display system further has an ID code generation unit 21 located in the information providing unit 20 and an ID unit 31 located in the display unit 30. The ID code generation unit 21 aims to generate an ID code 211 corresponding to the information providing unit 20 to the display unit 30. The ID unit 31 receives the ID code 211 and checks through an authentication data base 311. In the event that the ID code 211 matches the data in the authentication data base 311, a linking signal 312 is sent back to the ID code generation unit 21 so that the display unit 20 can receive and display video information generated by the information providing unit 20 through the wireless transmission modules 10a and 10b. In the event that the ID code 211 does not match the data in the authentication database 311, the ID unit 31 does not generate the linking signal 312 to the ID code generation unit 21. The ID code 211 is generated through a software or firmware by the ID code generation unit 21 to identify the information providing unit 20, and can include ID data such as name, key, model number, ID number and the like. The authentication data base 311 contains the data to determine the ID of different information providing unit 20, such as name, key, model number, ID number and the like of the information providing unit 20.

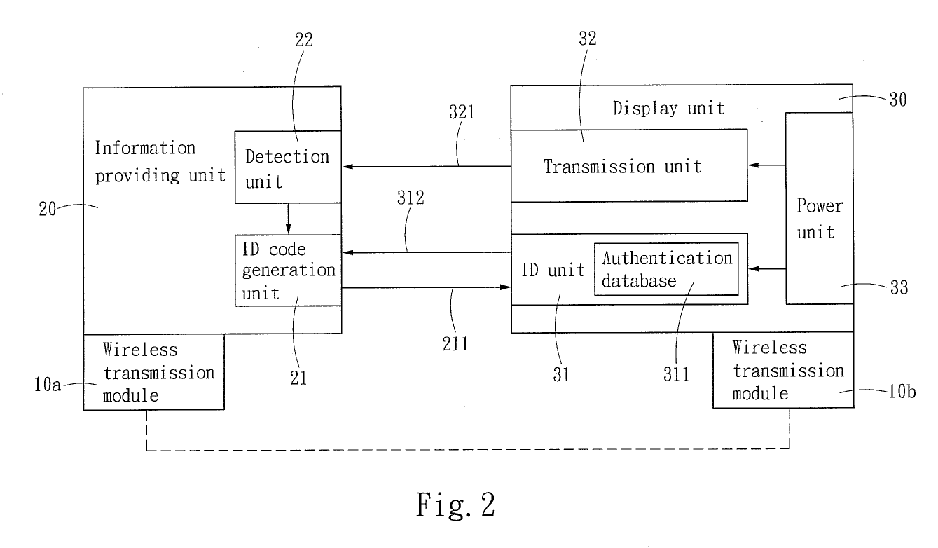

Please refer to FIG. 2 for the structural block diagram of another embodiment of the invention. The display unit 30 further includes a transmission unit 32 to generate a detection signal 321. The information providing unit 20 has a detection unit 22 to receive the detection signal 321. The detection signal 321 is a wireless ID signal such as an infrared signal, electromagnetic signal, microwave signal or the like. When the detection unit 22 receives the detection signal 321, it drives the ID code generation unit 21 to output the ID code 211 corresponding to the information providing unit 20 to the ID unit 31 of the display unit 30. In addition, the display unit 30 has a power unit 33 to provide electric power for operation of the display unit 30. The power unit 33 may be an electric power storage element (such as battery) or an external power cord.

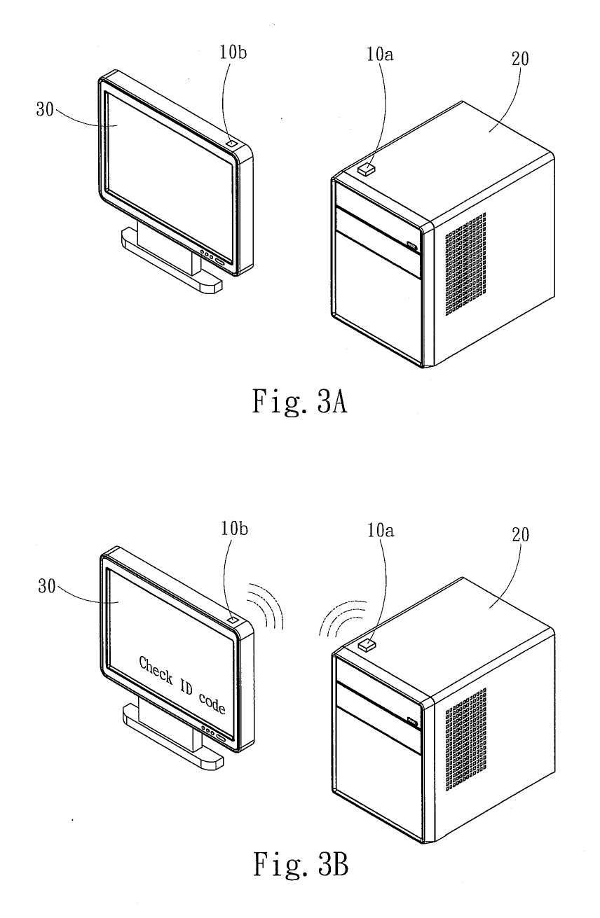

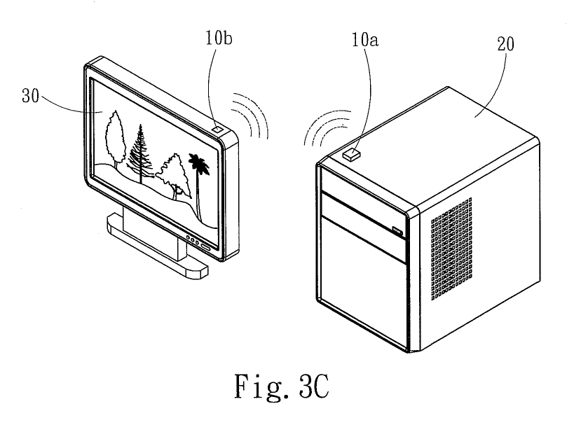

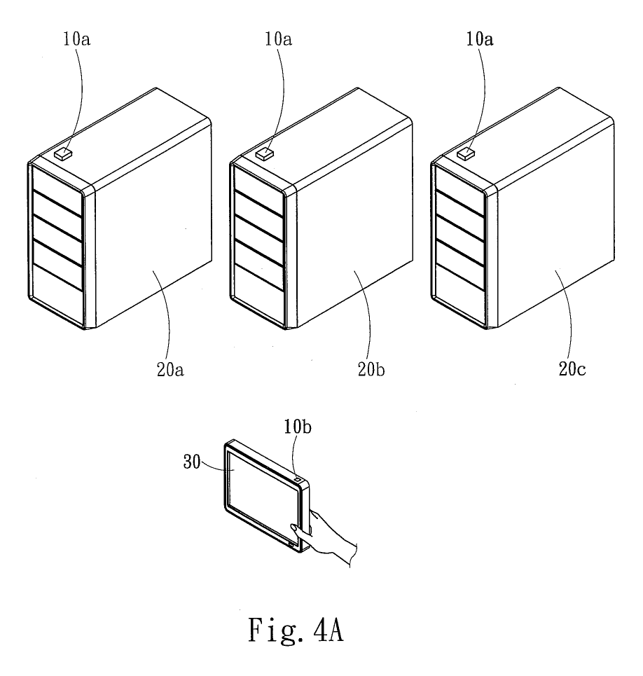

The wireless display system of the invention can be adopted to a wide variety of electronic devices. The information providing unit 20 may be a computer system, a video player, a video game console, or other multimedia players. The display unit 30 may be a flat panel display, a touch screen, a flexible display or the like to allow users to see and read video information. Refer to FIGS. 3A to 3C for an embodiment in which the wireless display system is adopted in a wireless transmission environment including a single computer system and a flat panel display device. As shown in FIG. 3A, the information providing unit 20 is a desktop personal computer, the display unit 30 is a flat panel display, and wireless transmission is not yet established between the information providing unit 20 and the display unit 30. Hence the display unit 30 cannot get video information from the information providing unit 20. The ID code generation unit 21 can continuously send the ID code 211, or the detection unit 22 can receive the detection signal 321 from the transmission unit 32 of the display unit 30 to be driven to generate the ID code 211. The display unit 30 receives the ID code 211 through the ID unit 31 and determines whether the ID code 211 matching the ID data in the authentication database 311 by checking therewith. Referring to FIG. 3B, in the event that the ID code 211 matches the ID data in the authentication database 311, the ID unit 31 sends the linking signal 312 to the ID code generation unit 21 to allow the display unit 30 and the information providing unit 20 to establish a wireless transmission linking state through the wireless transmission modules 10a and 10b. The display unit 30 receives and displays the video information generated by the information providing unit 20. Referring to FIG. 3C, in the event that the ID code 211 does not match the authentication database 311 the ID unit 31 does not generate the linking signal 312 in the ID code generation unit 21, hence no wireless transmission linking is established.

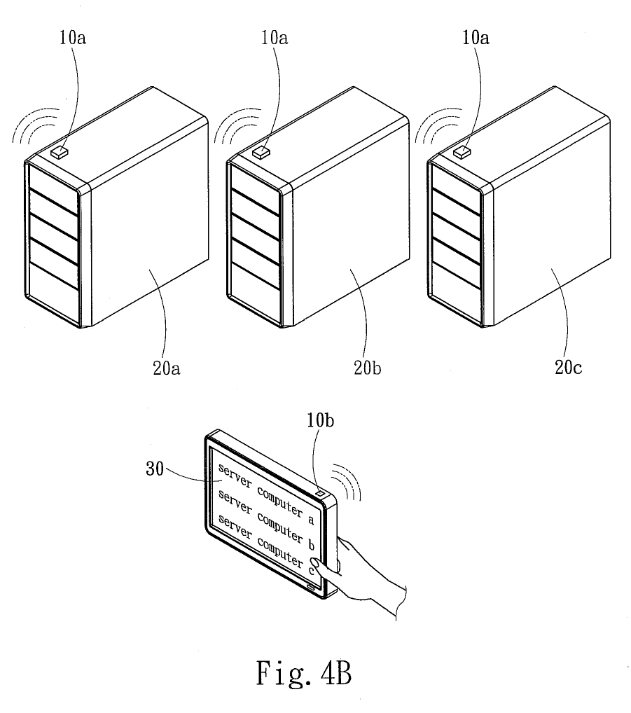

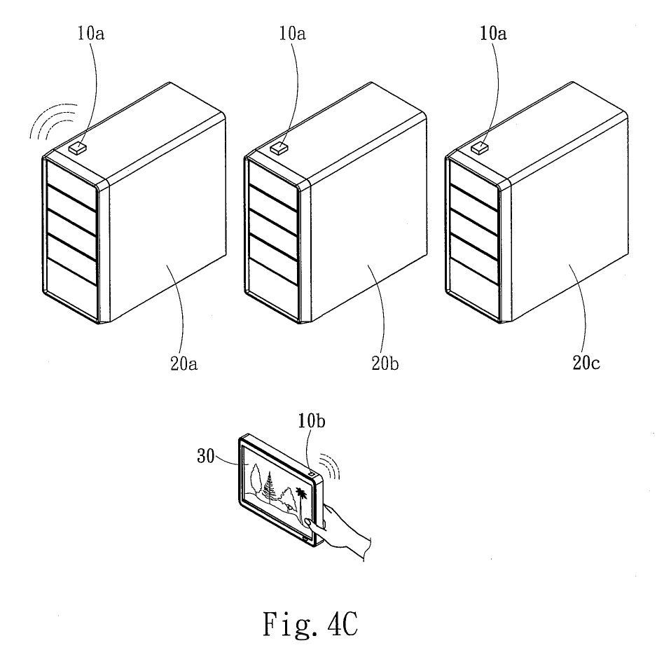

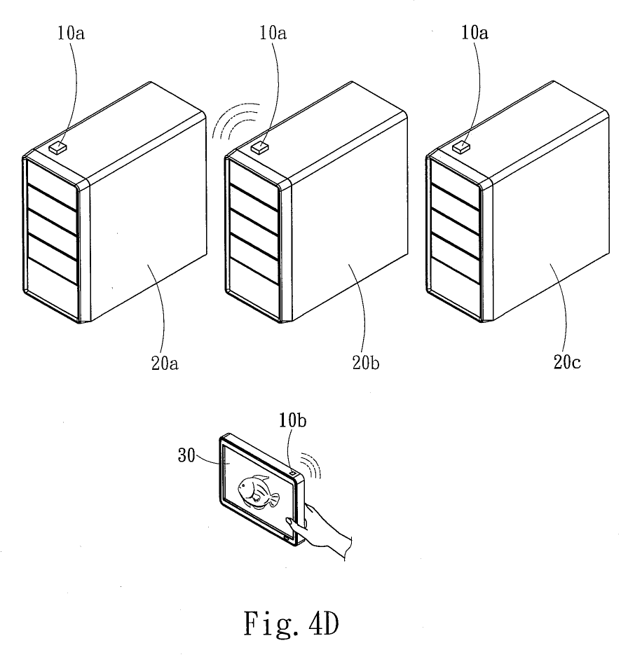

Moreover, the invention may also be adopted for wireless transmission between a single display unit 30 and multiple sets of information providing units 20 as depicted in another embodiment shown in FIGS. 4A through 4D. In this embodiment the information providing units 20 are multiple sets of server computers 20a, 20b and 20c. The display unit 30 is a portable display and can be carried by users to receive ID codes 211 issued by the different server computers 20a, 20b and 20c. After checking the authentication database 311 through the ID unit 31, the ID data of the server computers 20a, 20b and 20c can be displayed on the display unit 30 to be read by users (referring to FIG. 4B). Through the display unit 30 users can select which of the server computers 20a, 20b and 20c to be connected for wireless transmission. For instance, if the server computer 20a is chosen to be linked, the ID unit 31 of the display unit 30 sends the linking signal 312 to the ID code generation unit 21 of the server computer 20a so that the display unit 30 receives only the video information of the server computer 20a (referring to FIG. 4C). In the event that video information in other server computers 20b and 20c are to be accessed, a wireless transmission link to the other server computers 20b and 20c may be established (referring to FIG. 4D). Compared with the conventional approach which has to mate a corresponding display screen for each of the server computers 20a, 20b and 20c to access the video information stored inside, the invention requires merely one display unit 30 to achieve the same purpose. As during normal operations of the server computers 20a, 20b and 20c, there is no need to constantly monitor data processes on the display screen, adding a dedicated display screen on each of the server computers 20a, 20b and 20c incurs a higher cost. And more space also is needed to accommodate those display screens. The invention not only can be used on one type of information providing unit 20, may also be adopted to different types of information providing units 20, thus can greatly expand application scope of the display unit 30.

As a conclusion, the wireless display system of the invention can determine whether to establish a wireless signal link between the display unit 30 and the information providing unit 20 through the ID code 211. When the wireless signal link is established between the display unit 30 and the information providing unit 20, video information chaos that might otherwise occur to the display unit 30 due to receiving the video information from different sources can be prevented. Moreover, in an environment where multiple sets of information providing units 20 are presented, only one set of display unit 30 is required to mate different information providing units 20 to transmit video information. There is no need to provide a mating display unit 30 for each information providing unit 20. Thus cost and installation space can be reduced. In addition, by providing video information transmission between the display unit 30 and the information providing unit 20 through a wireless link, the application scope of the display unit 30 can be expanded to become more economically effective. Hence it offers a great improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A wireless display system to perform wireless transmission between at least one information providing unit and a display unit through a wireless transmission module, comprising:
an identification code generation unit located in the information providing unit to generate an identification code corresponding to the information providing unit to the display unit; and
an identification unit which is located in the display unit to receive the identification code and check the identification code through an authentication database, and send a linking signal to the identification code generation unit in the event that the identification code matches the authentication database so that the display unit receives and displays through the wireless transmission module video information generated by the information providing unit.

2. The wireless display system of claim 1, wherein the display unit has a transmission unit to generate a detection signal, the information providing unit having a detection unit to receive the detection signal.

3. The wireless display system of claim 1, wherein the display unit has a power unit.

4. The wireless display system of claim 1, wherein the display unit is a flat panel display.

5. The wireless display system of claim 1, wherein the display unit is a touch screen.

6. The wireless display system of claim 1, wherein the display unit is a flexible display.

7. The wireless display system of claim 1, wherein the information providing unit is a computer system.

8. The wireless display system of claim 1, wherein the information providing unit is a video player.

9. The wireless display system of claim 1, wherein the information providing unit is a video game console.

10. The wireless display system of claim 1, wherein the wireless transmission module is a Bluetooth module.

11. The wireless display system of claim 1, wherein the wireless transmission module is a wireless Universal Series Bus module.
